(19) United States
(12) Patent Application Publication
(10) Pub. No.: US 2003/0200200 A1
(43) Pub. Date: Oct. 23, 2003

(54) Content disclosure method and system

(76) Inventors: Mary Beth Hughes, Kingwood, TX (US); Scott Boyd, Kingwood, TX (US)

Correspondence Address: DELPHINE M. JAMES, 2656 SOUTH LOOP WEST #170, HOUSTON, TX, 77054, US

(21) Appl. No.: 10/126,373

(22) Filed: Apr. 19, 2002

(51) Int. Cl. G06F 7/00

(52) U.S. Cl. 707/3

(57) ABSTRACT

A computerized method and system for notifying a consumer whether identified elements are contained in selected products. The system consist of at least one computer server and hand held computing device interconnected in a client server environment. A manufacturer registers their UPC's with the system. A consumer registers their elements (ie allergy information) with the system. Utilizing a scanner connected to the handheld computing device, the consumer scans in the UPC codes of the selected products. The system compares the ingredients of the selected products is compared with the consumer's allergies. The results of the comparison is displayed to the consumer.

### BACKGROUND

Negative and harmful reactions to foods have been observed for thousands of years. Words like allergy, intolerance and sensitivity have been used to describe such adverse reactions. The term ‘allergy’ has been defined as an adverse reaction to a normally harmless substance which may be a food or other environmental substance like dust, pollen, mold, or chemical. Physicians debate the use of the word “allergy”. Below are the 3 type of reactions often reported:

A. Type I—Classical IgE mediated: These affect 7-8 million persons or 1.5% of the population. They can be serious and often life threatening. Symptoms can be swelling of specific areas, sudden or violent skin rashes, hives, vomiting, asthmatic breathing, heart attack-like symptoms, anaphylaxis or other sudden reactions affecting any part of the body.

B. Type II Delayed Food allergies—IgG, IgA, IgM or Cytotoxic in nature: These are much more common and affect about 45% of the population and are often implicated with chronic illness. These reactions can occur within 2 hours to 72 hours after ingestion, making them harder to identify. Common chronic illnesses like asthma, eczema, migraines, irritable bowel, runny nose, sinusitis, arthritis, and general poor health have been reported from this form of food allergy. Also called cyclic food allergy, symptoms can disappear with avoidance only to re-appear alter introducing the food back into the diet daily. Constant consumption of these foods can weaken the immune system.

C. Food Intolerance: Lactose intolerance is the classical example of this form of reaction. Food Intolerance is caused by the inability of the body to properly breakdown the food due to a lack of an enzyme or other physical problem. Individuals with any of these reactions need to be able to identified and eliminate the reactive food(s) from their diet in order to have optimum nutrition. Reading labels and understanding what they say is very essential, but often the labels are inaccurate, incomplete or confusing to the consumer. Words like whey, lactalbumin, galactose, recaldent and “natural ingredients” indicate the presence of milk—but many people do not have those words in their vocabulary and do not understand that these ingredients are milk derived. The food allergic person is the most discriminated person in America. A person allergic to milk cannot eat 80% of the processed foods in the grocery store and also has problems with pharmaceuticals since most compounded tablets contain lactose. To further complicate the problem, many sources of a food may be an the label of one product, i.e. milk solids, sodium caseinate, lactalbumin phosphate, whey, etc. and it is impossible to tell how much of that slice of bread contains milk.

D. Blood Type: Blood types react to antigens found in foods. Some foods can even be used to type blood due to the amount of agglutination (clumping) of cells For example, type O has antibodies to types A and B. This is why a type O can not get a transfusion from these blood types. Type O has no antigens so it can be donated to anyone. Type AB can take anyone's blood because it contains both the A and B properties. Most foods and other ingestible organics such as herbs and spices also have antigens. Antigens are substances that provoke an immune response as the body tries to eliminate it. They cause immune reactions like allergies. Depending on your blood type, certain foods are considered beneficial and others that provoke an immune response should be avoided. Many diseases and chronic illnesses are linked to foods and blood types. Below is a generalization of the blood types and general advice:

I) Type O: Should eat mostly meat and stay away from grains (especially wheat) and dairy products. They should also engage in vigorous exercise. Type O's typically get inflammatory disease such as arthritis or colitis, asthma and hay fever since their immune Systems is vigorous.

2) Type A: Should eat mostly a vegetarian diet and avoid most fats and dairy products. They do well on vegetables and grains. They respond well to gentle exercise. Type A's typically get heart disease or cancer when they eat poorly.

3) Type B: Rave the most varied diet and is the only one that dies well on dairy products. Chicken and corn are detrimental to type B's. Exercise should be moderate. Type B's typically get the slow-growing virus and immune disorders like MS.

4) Type AB: It is the friendliest immune system and will accept almost anything. It is also the rarest blood type. They do well with calming exercise. More information is available at www.ER4YT.com.

E) Misc. Any foods that a physician to patient chooses to avoid for various other reasons: drugs interactions, certain diseases like gout. Diabetes, candida etc.

Individuals with any of these reactions need to be able to identify and eliminate the reactive food(s) from their diet in order to have optimum nutrition. Reading labels and understanding what they say is very essential, but often the labels are inaccurate, incomplete and confusing to the consumer. Words like whey, lactalbumin, galactose, recaldent and “natural ingredients” indicate the presence of milk. but many people do not have those words in their vocabulary and do not understand that these ingredients are milk derived.

Below are some of the other current issues relating to food labeling:

Labeling:

1. Food and drug manufacturers have “trade secrets” and do not disclose all ingredients.

2. The ever-changing ingredients problem that occurs as manufacturers change supplier due to cost or supply changes. This requires label changes that are cost prohibitive.

3. Some milk allergic patients are only sensitive to the “whey” fraction of milk that contains the water-soluble proteins as well as the lactose. They can however eat certain cheeses and food without whey that will be excellent sources of calcium. No current labeling makes that distinction.

4. Full disclosure is also imperative. Current FDA guidelines for labeling result in confusion to the consumer. Words like chicken stock, broth, other ingredients. artificial colors and flavorings are too general. These Standards of Identity also conceal ingredients. Uncle Ben's rice has cornstarch but is not on the label. It is used to keep it from sticking.

5. Some ingredients are written so small that they can not be read. Equal and Sweet N Low are used by diabetics daily and most of them think it contains no sugar. The first ingredient is dextrose, which is sugar . . . but is it derived from cane, beet or corn sugar?

6. Since many forms of milk, wheat, soy, corn and e.g. are used in a single food item, they need to be identified by the percentage of their presence in the food. With milk, there needs be 3 distinctions; Whey, casein and lactose and the percentage of there presence. Then, the consumer is informed. Many allergic people can tolerate a small amount of certain foods but trace amounts of others can be dangerous or fatal. This is critical.

7. Label reading can take hours. With the Ingredient Discloser Scanning method, costly errors can be avoided. Eating out can be extremely difficult if not impossible for the allergic. Restaurants, hospitals, airplanes, schools, cafeterias and other public eating places do not disclose ingredients and often the personnel does not know or does not realize the importance of this and gives out incorrect information.

The Universal Product Code (UPC) bar code is nearly on every item purchased in a grocery store. However, the food ingredients of a product are not on the UPC bar code. The UPC code consists of a manufacturer identification number and an item number. The manufacturer's responsibilities include assigning item numbers to products, making sure the same code is not used on more than one product, and retiring codes as products are removed from the product line. Usually, every item the manufacturer sells needs a different item code. Additionally, every package size of a product and every repackaging of the product requires a different item code. The UPC bar codes were originally created to speed up the checkout process and keep track of inventory. Thus, currently there is no way to conveniently determine what allergens are in food products before the food product is purchased.

Today, the Internet is utilized as an information superhighway providing universal access to quality information through computer communications. The Internet is the interconnection of computer networks that enables connected machines to communicate directly. Internet's are formed by connecting local networks through special computers in each network known as gateways. Gateway interconnections are made through various communication paths including telephone lines, optical fibers, and radio links. Information to be delivered is tagged with the destination computer address. Once addressed, the information leaves its home network through a gateway. It is then routed from the gateway to gateway until it reaches the local network containing the destination machine.

The data communication protocol used to route information is Transmission Control Protocol/Internet Protocol (TCP/IP). The IP specifies how gateway machines route information from the sending computer to the destination computer. The TCP checks whether the information has arrived at the destination computer and, if not, causes the information to be resent.

Internets allows information to pass between computers. The hypertext transfer protocol (http) is the information transfer protocol that is the basis for the collection of distributed information called the World Wide Web (WWW). HTTP provides the capability to read and interpret files on remote computer machines, not only text, but pictures, sounds and video information. The WWW is a collection of files, called web sites or web pages. These files are identified by uniform resource locators (URLs) that specify the transfer protocol (i.e. http), the remote machine's internet address, and the file name (i.e. web page). Computer programs known as browsers, such as Netscape or Microsoft Internet Explorer, use http to retrieve these web pages. Today, the WWW is one of the most efficient methods of communicating information to a person and is used to implement many computerized systems.

What is needed is a computerized system and method for electronically reading ingredients from a food or drug product label, determining whether a person will have an allergic reaction to the product, and communicating this information back to the person in an efficient manner.

### SUMMARY

The present invention provides a computerized method and system for notifying a consumer whether identified elements are contained in selected products. The system consist of at least one computer server and hand held computing device interconnected in a client server environment. A product database containing the product information is created and maintained on the computer server. The database record consists of an UPC code and a list of elements (ie allergy components) based upon the contents of each product. A consumer database containing consumer registration information is created and maintained on the computer server. The database record consists of a list of personal information and list of elements (ie allergy information) for each registered consumer.

A consumer utilizing web browser software executing on a PC registers with the system by providing personal and allergy information. The consumer provided information is then stored in the consumer database. After a consumer successfully registers with the system, utilizing a hand held computing device equipped with a scanner, the consumer scans UPC codes off of the labels attached to the selected manufactured products. The system retrieves the allergy components of each of the selected products from the manufacturer database. Then, the system retrieves the list of consumer's allergies from the consumer database. The system compares the two lists and displays the results to the user on the hand held computing device.

### DRAWINGS

FIG. 1A is a data flow illustrating the logical structure of the system in one embodiment of the present invention.

FIG. 1B is a block diagram illustrating one embodiment of the computer system physical environment to support the present invention.

FIG. 2A illustrates a sample record structure for the product code databases.

FIG. 2B is a flow chart of how the system creates the product code databases.

FIG. 3A is a flow chart illustrating how a consumer can register with the system utilizing a web browser.

FIGS. 3B-3F illustrates a sample structure of the web pages to support the consumer registration process utilizing the web browser.

FIG. 3G is a flow chart illustrating how a consumer determines whether they are allergic to a manufactured product utilizing a micro-web browser on a handheld computing device.

FIG. 3H illustrates a sample web page to support the micro-web browser.

FIG. 4. is a flow chart illustrating how the web server processes requests from the web browser and micro-web browser.

FIG. 4A is a sample structure for the consumer database which stores all the consumer registration information.

FIG. 4B is a sample structure for the blood table which contains a list of possible food allergies for each blood type.

FIG. 5A is a block diagram for an alternative embodiment for the present invention.

FIG. 5B is a flow chart illustrating the steps in transferring the databases stored on the web server to a memory module stored on the handheld computing device.

FIG. 5C is a flow chart illustrating the steps involved in determining whether a consumer is allergic to a manufactured product utilizing the handheld computing device for the alternative embodiment illustrated in FIG. 5A.

FIG. 5D is a sample User Interface to support the alternative embodiment illustrated in FIG. 5A.

### DETAILED DESCRIPTION OF THE INVENTION

The present invention provides a method and a system for notifying a consumer of particular elements contained in selected products. The system of the present invention can quickly and effectively determine if products contain specific elements at the time of purchase as well as evaluating products already purchased.

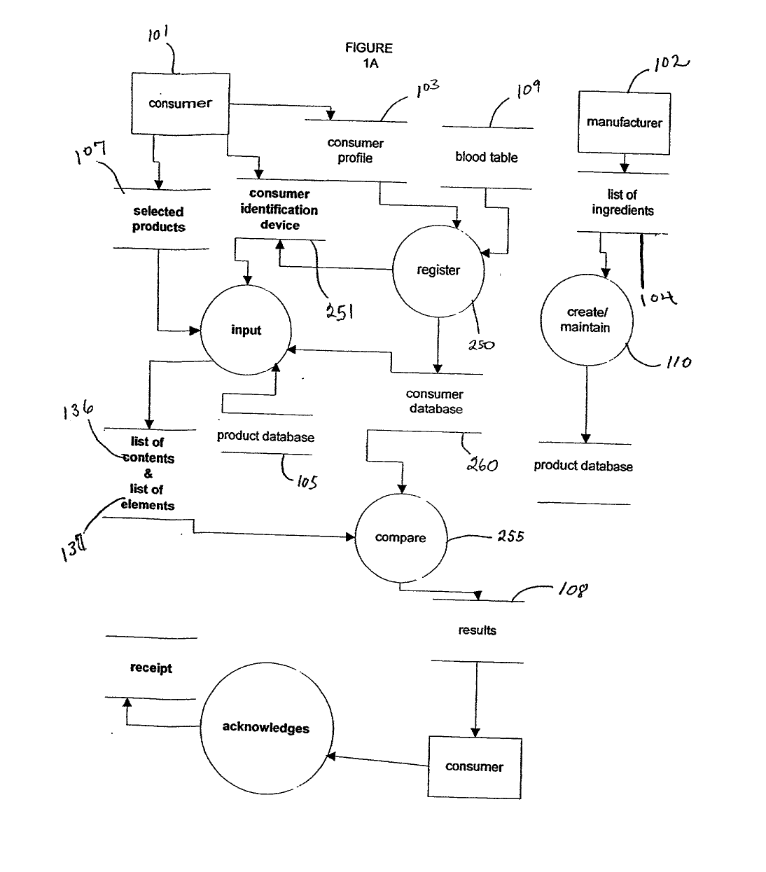

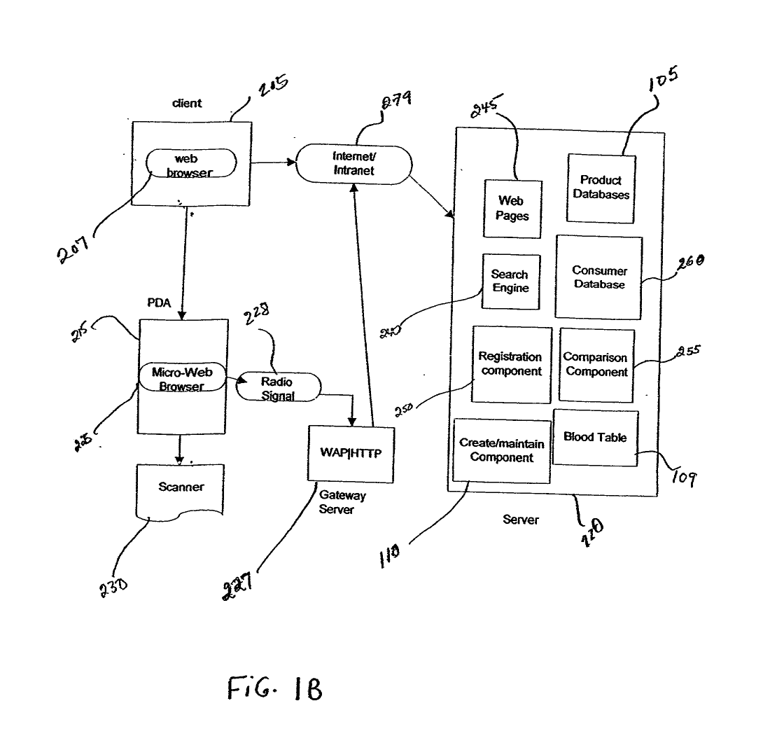

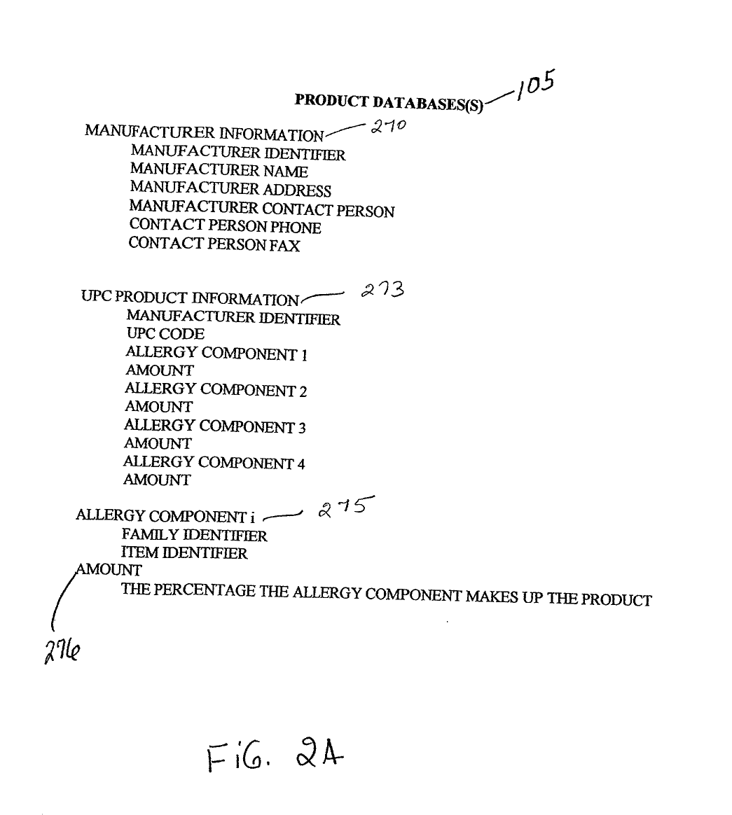

FIG. 1A is a data flow illustrating the logical structure of the system in one embodiment of the present invention. In the illustrated embodiment, a consumer (101) registers (250) with the system by providing a consumer profile (103). A consumer can be a person, animal, or an entity. An entity can be a corporation or other such possible legal entity. The consumer profile (103) includes a list of elements the customer wants to be notified that are contained in selected products. The list of elements can be food ingredient or any product ingredient that the consumer could have an allergic reaction to. Additionally, the list of elements could be elements of products the consumer wants to be notified of. The consumer can provide the consumer profile (103) by a written or verbal application which is later entered into the system, by accessing the system web site on the Internet, or by accessing a user interface on an internal local network. A consumer database (260) can be created and maintained from the consumer's consumer profile (103) provided by each registered consumer (101). The consumer database (260) can be a single table or a plurality of related tables.

In an even more specific embodiment of the present invention, a blood table (109) containing a list of elements to be identified for each possible blood type is created and maintained. Based upon the blood type provided by the consumer during registration, an additional list of elements is retrieved from the blood table (109) and is added to the consumer's profile (103).

In the illustrated embodiment, after the consumer completes the registration (250) process, the consumer is provided a consumer identification device (CID) (251) to later access the system. The registration process can be with a retailer, wholesaler, distributor, reseller, or independent third party. The retailer, wholesaler, distributor, reseller or independent third party can provide the consumer with a CID (251). The consumer identification device (CID) (251) is a reference that links the consumer to the registered profile. CID (251) can be a Personal Identification Number (PIN), magnetic card device, smart card device, finger print, retina eye scan, or other such type of identification device.

When the consumer decides to purchase products from a retailer, manufacturer, distributor or reseller, the consumer presents CID (251) for validation. At step (132), the CID (251) is inputted into an electronic computing device for validation. The electronic computing device can be a hand-held computer, point of sale computer, static portable scanning device, or other such computing device. The CID can be inputted into the system's electronic computing device by a data entry device, card reading device, finger print scanning device, retina eye scanning device, text scanning device, bar code scanning device, or such type of compatible computing device.

In the illustrated embodiment, the system electronic computing device can be located in an establishment where products are purchased by consumers or where consumers store the purchased products, (i.e., retailer, manufacturer, distributor, reseller, or wholesaler). Additionally, the electronic computing device can be located in the home of the consumer to test products already purchased. The electronic computing device has the capability of accessing the customer database (260) and validating the CID with what is stored in the customer database (260). The customer database (260) can be stored locally on a storage device connected to the electronic computing device or on a local area network server or on a wide area network server. The electronic computing device can access the computer database (260) utilizing the Internet, an intranet, modem line, or some type of data communication link.

In this illustrative embodiment, a manufacturer (102) of products also registers with the system by providing product information (104) containing the list of contents and product code for each of their product to be stored in the system. Each product is identified by a product code physically located on the product. The product code can be a UPC bar code or other such compatible code. From the provided product information (104), product database(s) (105) are created and maintained (110). The product database (105) can be a single table or a plurality of tables.

Then, to use the system, a consumer (101) selects products to be tested. At step 134, the product code of each of the selected products (107) is inputted into the electronic computing device. The selected products (107) can be inputted via a scanner attached to the electronic computing device. The selected products (107) can also be inputted via a beaming radio signal, transponder or another such compatible process. The list of contents (136) for each of the selected food products (107) is retrieved from the product database (105).

At step 132 after the CID (251) validation is complete, the list of elements (137) for the validated consumer is retrieved from the consumer database and then, inputted into the electronic computing device. The retrieved list of elements can be directly stored in a temporary buffer area in the electronic computing device. Then at step 255, the list of contents (136) of each selected products is compared with the retrieved list of elements (137). The results (108) of the comparison are presented to the consumer (101).

The illustrated embodiment further includes the capability of notifying the consumer verbally, in writing, or visually whether or not the identified elements are contained in selected products (107). After notification to the consumer, the consumer is required to acknowledge by signature or verbally, that they are purchasing or receiving products that contain the elements identified in their profile. The consumer can then choose to purchase the product or use the product. The comparison process (255) is done efficiently so that the consumer (101) instantaneously knows whether or not the selected products are appropriate.

In the present invention a plurality of product databases can be created to support the system of the present invention. Various databases can be created to support the various services provided by the system to the consumers. The system can provide services to:

1. Hospitals for food prepared for patients

2. Airplanes for food prepared for passengers

3. School cafeterias for food prepared for students

4. Preschool cafeterias for food prepared for students

5. Drug stores for consumers who buy their products

6. Grocery stores for consumers who buy their products

7. Restaurant for menu items prepared for their customers

8. Manufacturer for consumers who want to test for allergic reactions

Referring to FIG. 1B, there is shown a block diagram of a system configuration, which can support one embodiment of the present invention. The system is implemented in a client-server environment. In the illustrated embodiment, the system further includes at least one client computer (205), at least one hand-held Personal Digital Assistant (PDA) (215) and at least one Web Server Computer (220) interconnected via the Internet or an Intranet (279). An intranet is a smaller Internet for private use by a single organization or a group of organizations.

The client computer (205) can be a Personal Computer, Lap Top, Notebook or another such compatible computer processing system. The client computer (205) further includes a web browser (207). Web browser (207) is software which provides the capability of connecting to the web server (220), requesting web pages from the web server (220), pulling the web pages through Internet (279), interpreting the set of HTML tags within the web pages (245), and displaying the web pages (245) on the screen of the client computer (205). Web browser (207) can be any commercially available software product, such as Netscape or Microsoft Internet Explorer.

The Personal Digital Assistant (PDA) can be a Palm Computer, Handspring Visor, or any such compatible hand held processing computer. PDA (215) further includes a micro-web browser (225). The micro-web browser (225) is smaller version of web browser (207) and provides wireless communication to web server (220). Currently, there are some commercially available micro-web browsers. However, for the present invention micro-web browser (225) will require additional capabilities to interface with scanner (230). In the illustrated embodiment, micro-web browser (225) provides wireless communication to Web server (220) through gateway server (227). Micro-web browser (225) communicates with gateway server (227) via radio signal (228) utilizing the wireless access data communication protocol (WAP). Request for web pages (245) are encoded in the WAP and are sent by micro-web browser (225) over radio signal (228) to gateway server (227). The gateway server (227) receives the requests, converts the WAP to HTTP, retransmits the requests over the Internet (279) to Web server (220). After the web server (220) receives the requests for web pages (245), the web server (220) sends the web pages encoded HTML over the Internet using the data communication protocol, HTTP. The gateway server (227) receives the web pages and converts them into the wireless markup language (WML), and retransmits to the PDA (215) over the radio signal (228). The WML is smaller version of HTML specifically designed to support hand-held computer devices. Thus, micro-web browser (225) interprets the WML tags and displays on the web pages on the screen of the PDA (215) Scanner (230) provides the capability to scan in the UPC bar codes from the manufactured products and to provide the scanned bar information to the micro-web browser (225). In this kind of embodiment, scanner (230) scans in the UPC bar code, converts the bar code into text, and provides the value to micro-web browser (225). Scanner can be the CSM 150 scanner manufactured by Symbol Technologies or another such compatible processing system.

The web server can be any commercially available server computer with the processing capacity. In the illustrated embodiment in FIG. 1, web sever (220) further includes search engine (240), web pages (245), blood table (109), registration component (250), comparison component (255), and consumer database (260). Search engine (240) process HTTP requests for web pages (245) from web browser (205) and micro-web browser (225). Registration component (250) processes the consumer's registration and stores the consumer information in consumer database (260). Utilizing product databases (105), blood table (109), and consumer database (260), comparison component (255) processes consumer requests from PDA (215) to determine whether a consumer is selecting a product containing elements they wish to be notified of.

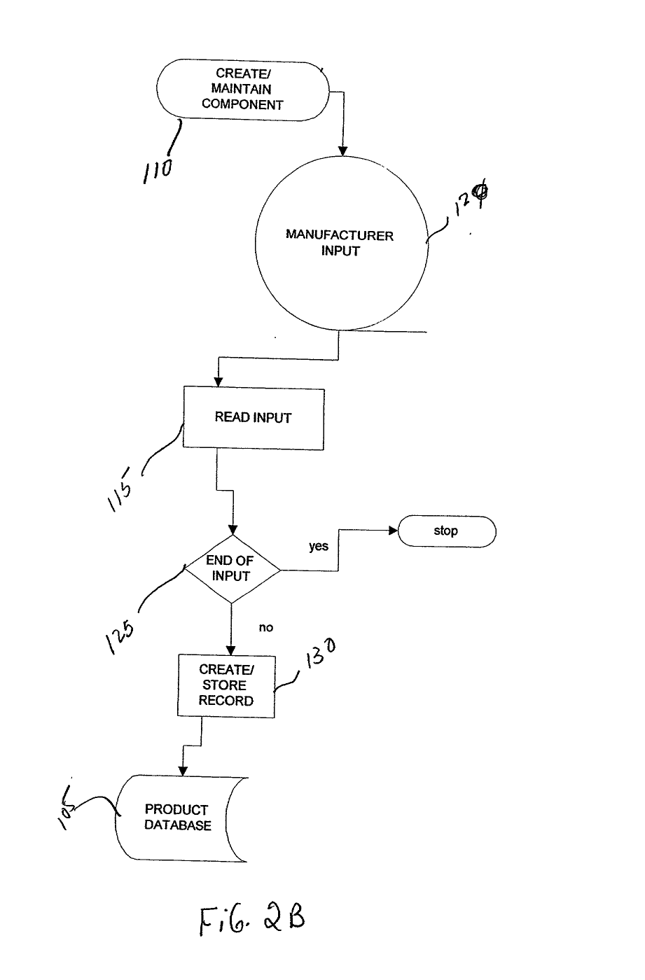

Referring now to FIG. 2A, there is illustrated a flow chart of how the Create/Maintain Component (110) creates the product databases (105). At step (115), the manufacturer input (120) is read into the system. In this embodiment, a manufacturer can be for any possible consumable good, manufactured non-consumable good, or any product sold in its natural state. Additionally, the input list (120) can be provided to the system by paper or by electronic media such as CD ROM or floppy disk. The provided input list (120) would contain for each manufacturer assigned UPC code a list of contents along with the amount of that ingredient contained in the product. In a more specific embodiment of the present invention, an item on the list of contents can be a class of a content (i.e. class of Milk which includes lactose, etc).

At step 125, in the illustrated embodiment, each item on the input list (120) is manually inputted into the system or read from the electronic media until the end of the list is reach. Next, at step 130, a database record is created for each item read from the input list (120). For each item on the list, a database record (132) containing the list of ingredients along with a corresponding list of allergy components. Then, at step 135, the created database record (132) is stored in product code databases (105).

FIG. 2A represents a sample record structure that can support product databases (105). The record structure includes the following elements:

1. Manufacturer information table (270) containing all the registered manufacturers

2. UPC information table (273) containing a list of allergy components for each manufactured product; additionally, an UPC information table can be created for each type of service provided by the system.

3. An allergy component (275) containing 2 parts: a family group id code and a special item identifier within that family group for the particular product; the family group id code is generally used for food products.

4. The amount (276) defining the percentage a specific allergy component makes up a particular product.

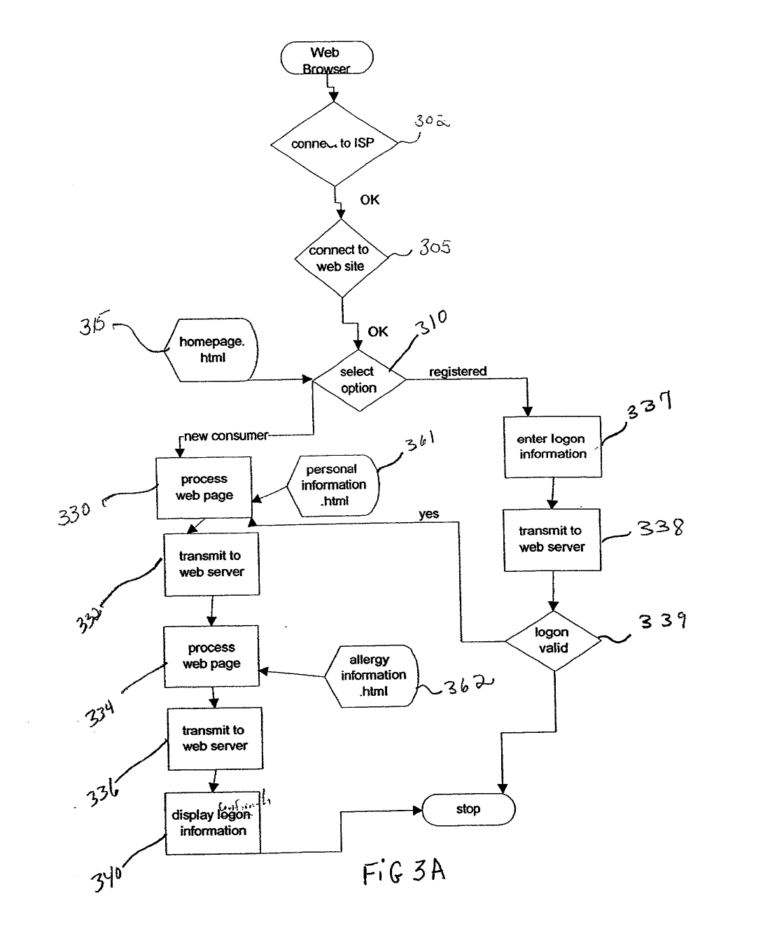

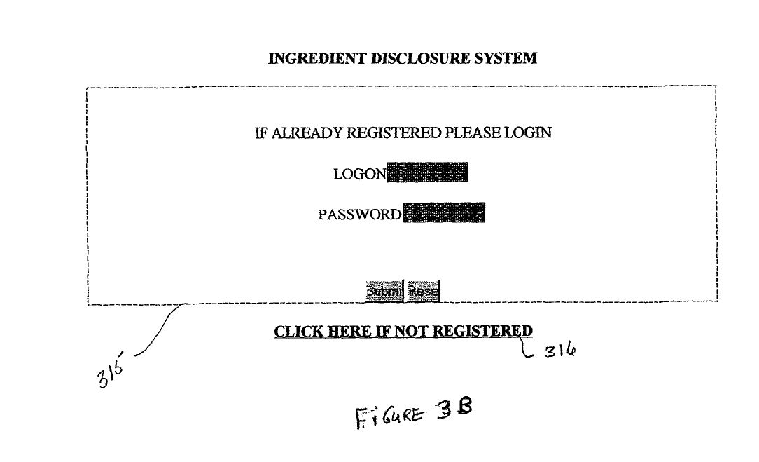

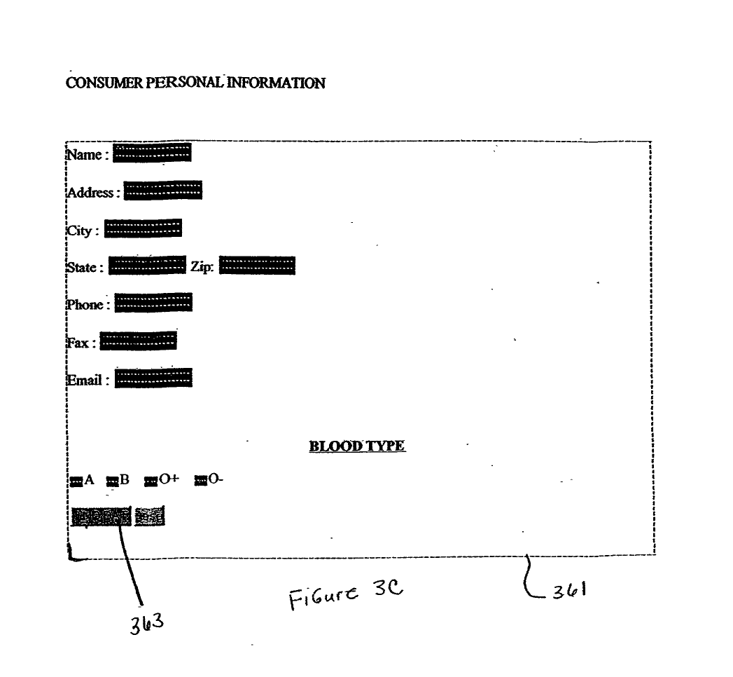

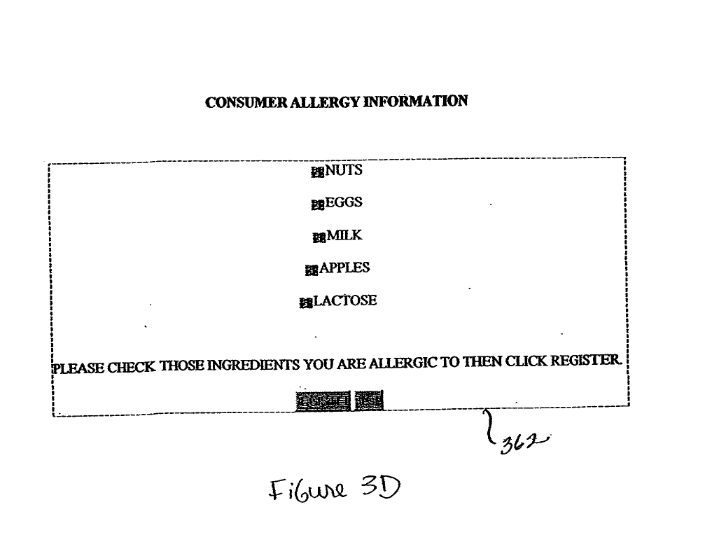

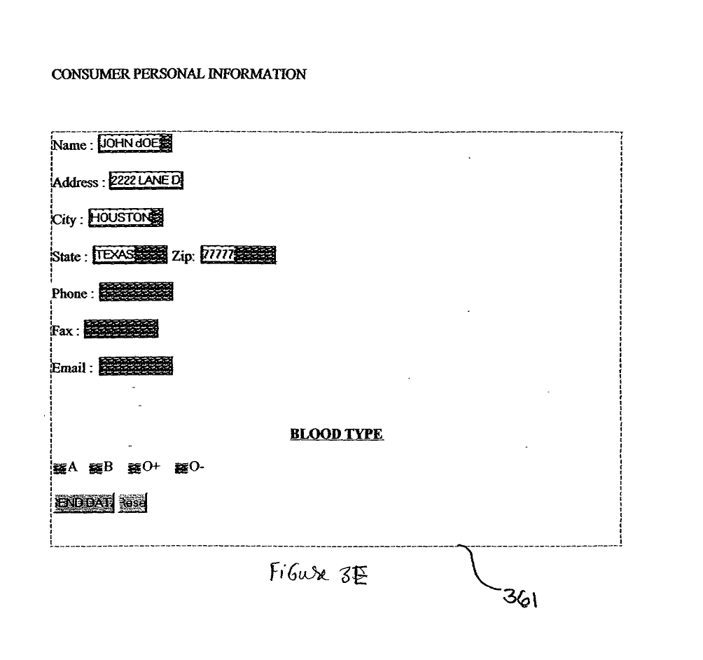

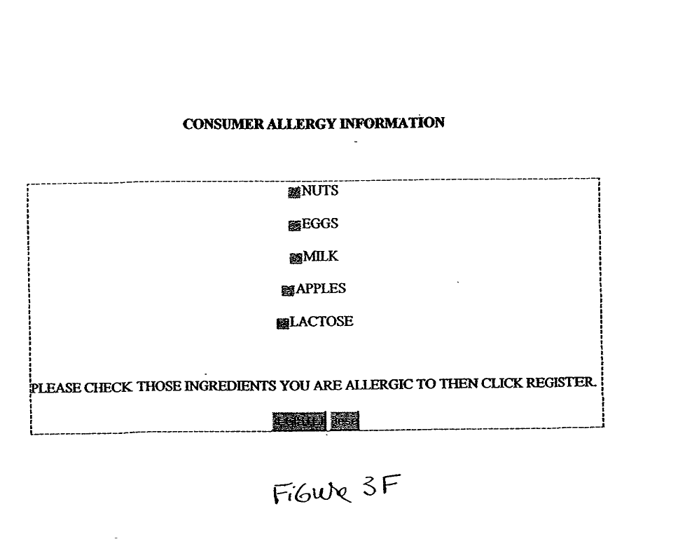

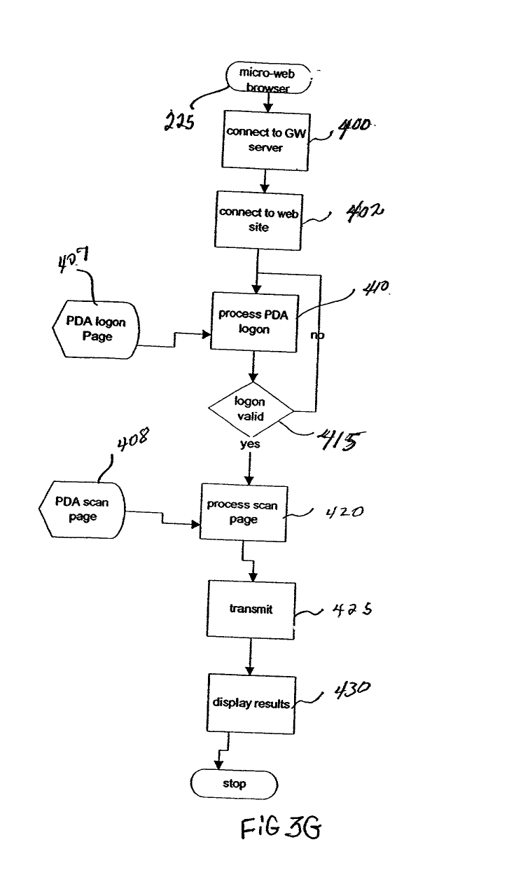

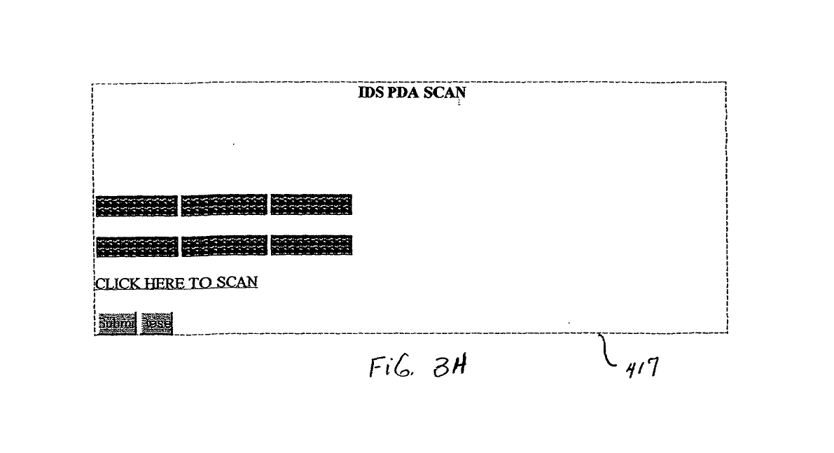

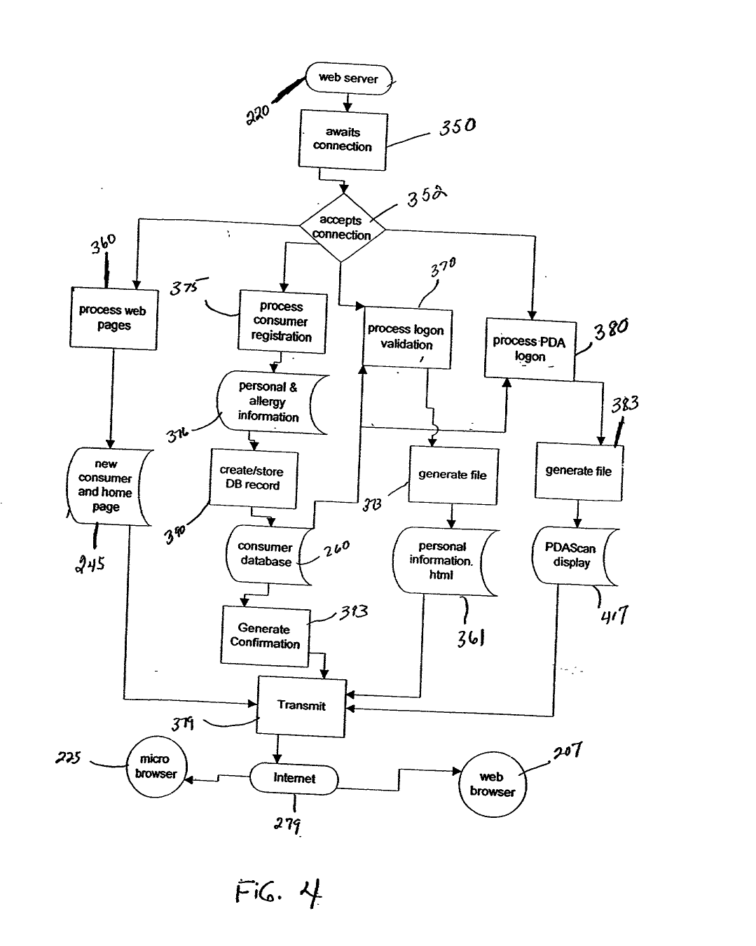

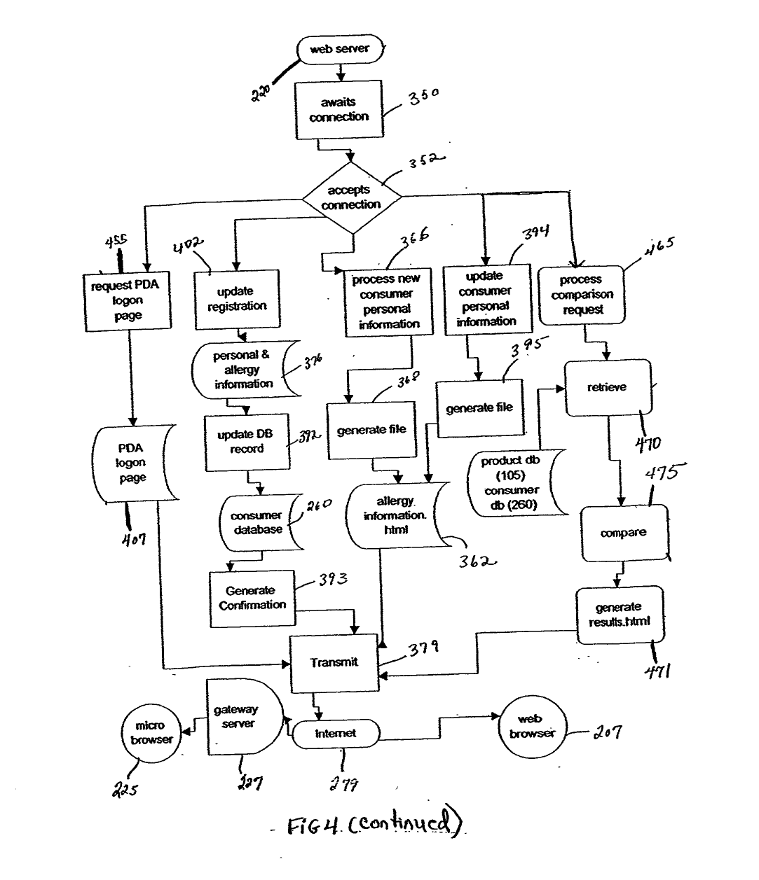

Referring now to FIG. 3A, there is illustrated a flow chart of one embodiment of how the present invention registers a consumer. In the illustrated embodiment, first, utilizing the web browser, the consumer at step 302 connects to its Internet Service Provider (ISP). If the connection is established with the ISP, at step 305, the consumer request the home page of the web server by entering the URL of the web site, for example (“www.IDS.com”). The web browser then tries to establish a TCP/IP connection with the web server. If the web browser establishes the connection to the web server at step 305, an HTTP document request for the home page is made and an the actual html file is returned to the web browser. At step 310, the web browser reads the homepage.html (315) file sent by the web server, interprets the HTML tags in the file and displays the file on the computer screen. A sample of homepage.html (315) is illustrated in FIG. 3B. The home page (312) provides the consumer the option of selecting the “not registered” or “registered”. At step 310, if the consumer selects “not registered” option from the homepage (315) then, an HTTP document request for the web pages to obtain the consumer information web pages is sent to the web server. The consumer information web pages consist of personal and allergy information as illustrated in FIGS. 3C and 3D, respectively.

At step 330, web browser reads the consumer's personal information web page file (361), interprets the HTML tags in the files, and displays the files on the computer screen. Utilizing the consumer's personal information web page (361), a consumer enters their personal information. Next in step 330, web browser (205) captures the information inputted into the consumer information web page (361). Then, at step 332, the new consumer's information is transmitted to web server when the consumer clicks on the “SEND DATA” button. After the web server completes processing the new consumer personal information, the allergy information web page (362) illustrated in FIG. 3D is sent back to the web browser. Utilizing the consumer's allergy information web page (362), a consumer enters their allergy information. Next, at step 334, web browser (205) captures the information inputted into the consumer information web page (362). Then, at step 336, the new consumer's information is transmitted to web server when the consumer clicks on the “REGISTER” button. After the web server completes processing the new consumer's allergy information, a confirmation screen is returned to the web browser containing the consumer's logon information. The consumer uses this logon information to subsequently access the system.

In the illustrated embodiment, if the consumer selects the “registered client” option, the consumer must enter logon information into the homepage (315) at step 337. When the consumer clicks on the submit button, the logon information is sent to the web server at step 338. At step 339, if the logon is validated by the server, then the web page containing the consumer's personal information is sent back to the web browser. Illustrated in FIG. 3E is a sample of an update personal information web page (361). The system proceeds at step 330 to allow the consumer to update their personal information utilizing the web page (361) sent back to the web browser. The consumer's inputted information is captured by the web browser and sent back to the web server in a HTTP document request at step 332. After processing the personal information, the web server returns the allergy information web page (362) with previously entered information. Illustrated in FIG. 3F, is a sample of an update allergy information web page. At step 334, web browser (205) reads the file allergyinformation.html (362), interprets the HTML tags in the files, and displays the files on the computer screen. Utilizing allergy information web page (362) the consumer enters their updated allergy information, web browser (205) captures the registered consumer's allergy information. Next, at step 336, web browser (205) transmits the updated consumer's allergy information (362) to the web server. Finally, in step 340, the system displays an update confirmation screen returned by the web server.

In this kind of embodiment, after a customer registers or updates their personal and allergy information with the system, the customer utilizing a PDA equipped with a scanner can now test products. Illustrated in FIG. 3G is a flowchart of one embodiment of the present illustrating how a consumer can scan selected products for their contents.

Referring now to FIG. 3G, at step 400 the consumer connects to the Gateway server utilizing a radio signal. Then at step 402, a customer utilizing micro-web browser (225) makes an WAP document request to gateway server for the logon page from the web server using a URL, for example (“www.IDS.com/PDAlogonpage.wml”). The gateway server receives the WAP document request, converts the WAP document request to an HTTP document request (“www.IDS.com/logonpage.html”), and makes a connection to the Web server. Gateway server receives the pdalogonpage.html (407) web page from the web server, converts the web page to logonpage.wml, and transmits the web page to the micro-web browser (225).

At step 410, micro-web browser (225) reads the pdalogonpage.wml (407) file sent by gateway server, interprets the WML tags in the file and displays the file on the PDA computer screen. A sample of PDAlogonpage.wml (407) is illustrated in FIG. 3H. Utilizing PDAlogonpage.wml (407), the customer provides the system a logon and password. When the consumer clicks the submit button, the consumer's logon information is sent to gateway server (227). Gateway server receives the logon information and forwards the information onto web server (220). At step 415 if the web server validates the consumer's logon information, the web server returns the PDA scan web page illustrated in FIG. 3H. The PDA scan web page (408) is utilized by the consumer to select products to test for allergic reactions.

At step 420, micro-web browser (205) reads the PDAscan.wml (417), interprets the WML tags in the file, and displays the files on the PDA computer screen. At step 420, utilizing PDAscan.wml (417), the consumer scans the UPC codes from labels attached to the selected manufactured products into the PDA. The scanned codes (419) are converted into ASCII text for transmission to the web server. When the consumer clicks on the submit button, the selected products are transmitted at step 425 to the web server through the gateway server. Then, at step 430, after the web server is completed processing the PDA scan web page (408), the results of the comparison are sent back to the micro-web browser through the gateway server and the results are displayed to the consumer.

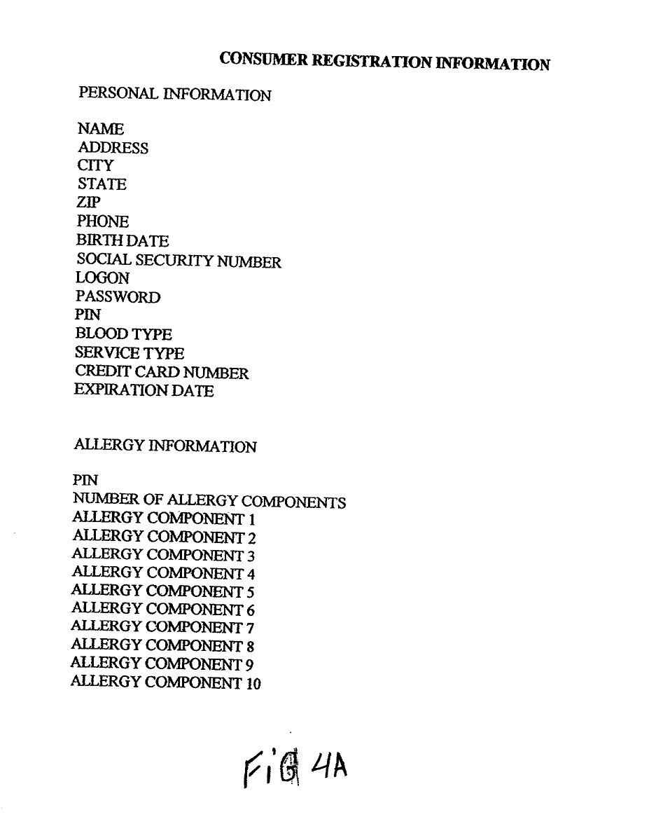

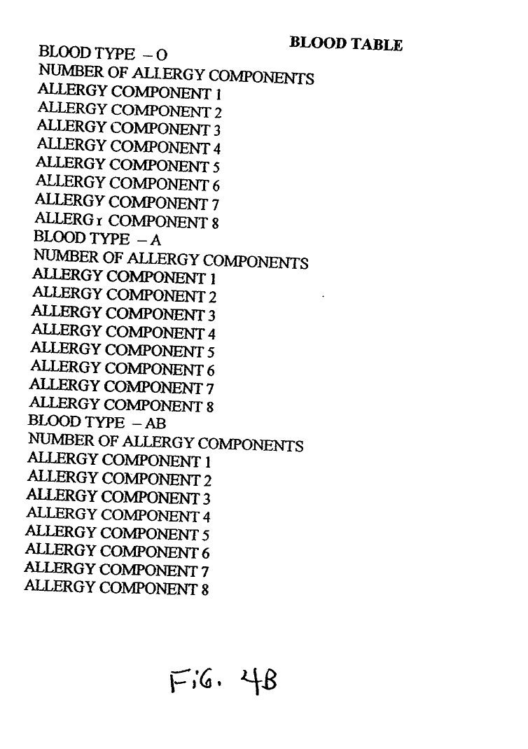

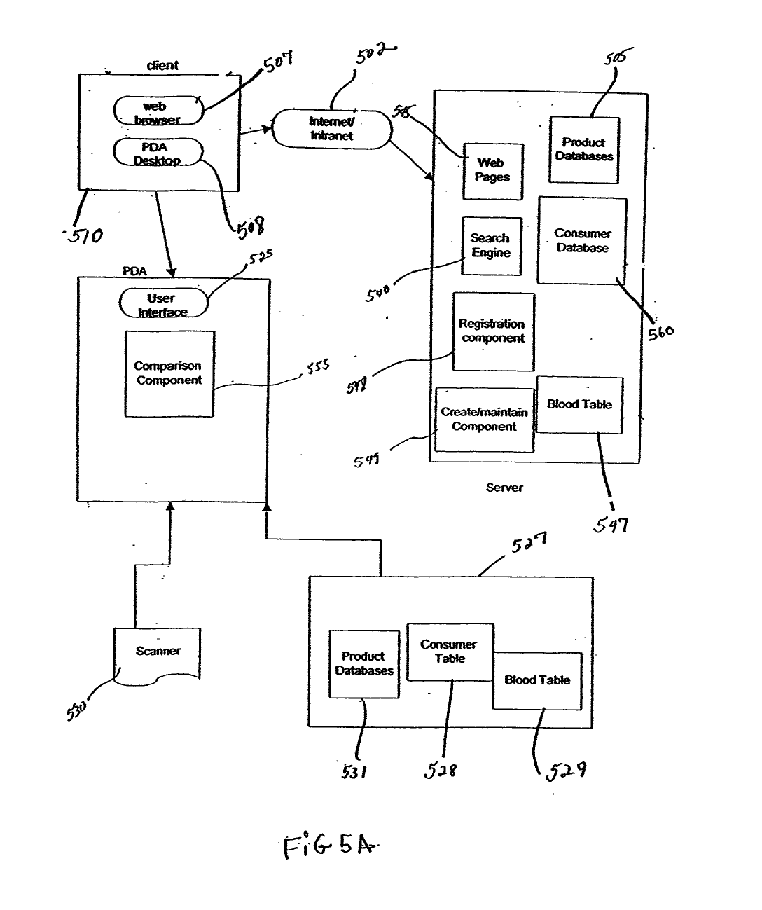

Referring now to FIG. 4, there is illustrated a flow chart of one embodiment of how the server (220) in this kind of embodiment of the present invention processes requests from the web browser (207) and the micro web browser (225). In this kind of embodiment, at step 350, the web server awaits an HTTP request over the Internet (279) from the web browser (207) or micro web browser (225). At step 352, the web server (220) accepts the TCP/IP connection, receives the HTTP request from the Internet (279) and interprets the HTTP document request. In step 352, the server determines what type of HTTP document request. In the illustrated embodiment, the received document request can be for IDS home page, new consumer personal information web page, process new consumer personal information, new consumer registration, web browser logon validation, process update consumer personal information, update consumer registration, PDA home page, PDA logon validation, and PDA comparison request.

In this kind of embodiment, if the request is for the IDS home page and the new consumer personal information web page, the server engine at step 360 determines where on the system the requested web page resides. In step 360, the requested web page is retrieved and transmitted (379) to the web browser (207) on the Internet or Intranet (279) over the TCP/IP connection.

In this kind of embodiment, if the request is to process a consumer registration, the web server initiates execution of the registration component (250) script at step 375. In step 375, the registration component 250 retrieves the customer's personal and allergy information (376) from the transmitted request. Then, at step 390, a new database record is created from personal and allergy information (376) and stored in consumer database (260). In step 390, an additional list of allergies is retrieved from the blood table (109) based upon the consumer's provided blood type. This additional list of allergies is also stored in the consumer database (260). Illustrated in FIG. 4A is an example of one possible embodiment of the record structure for consumer database (260) and illustrated in FIG. 4B is an example of one possible embodiment of the record structure for blood table (109). Finally, in step 393, a consumer confirmation display.html file is generated and transmitted (379) to the web browser (207) over the TCP/IP connection on the Internet. (279).

In this kind of embodiment illustrated in FIG. 3G, if the request is a logon validation request from the web browser (207), the web server initiates the execution of a standard logon validation script. In step 380, the logon information is captured from the transmitted request and validated against what is stored in consumer database (260). In step 383, if the logon information is valid, the personalinformation.html (361) file is created from the consumer information stored in customer database (260). Then, at step 375, the created personalinformation.html (361) file is transmitted (379) over the TCP/IP connection on the Internet back to the web browser (207). In this kind of embodiment, if the request is a PDA logon validation request, at step 380, the web server (220) initiates the execution of a standard logon validation script. Then, in step 380, the logon information is captured from the transmitted request and validated against what is stored in consumer database (260). If the logon information is valid, PDA scan display.html (417) is created and then, transmitted (379) over the TCP/IP connection on the Internet (279) back to the micro-web (225) browser via the gateway server (227).

In this kind of embodiment, if the request is to process the new consumer's personal information, in step 366, the registration component (250) is executed to capture the consumer's personal information from the transmitted request. Then, at step 368, the allergy information.html (362) file is created and the captured personal information is hidden within the allergy information for processing in the final registration request. The allergy information.html (362) file is transmitted in step 379 over the TCP/IP connection on the Internet back to the web browser (207).

In this kind of embodiment, if the request is to process the updated consumer's personal information, in step 394, the registration component (250) is executed to capture the consumer's personal information from the transmitted request. Then, at step 395, the allergy information.html (362) file is generated containing previously entered consumer information. Additionally, the captured personal information is hidden within the allergy information.html file for processing in the update registration request. The generated allergy information.html (362) file is transmitted in step 379 over the TCP/IP connection on the Internet (279) back to the web browser (225).

In this kind of embodiment, if the request is to process the update registration, at step 402, the web server initiates execution of registration component script 250. In step 402, registration component 250, retrieves the personal and allergy information (376) from the transmitted request. Then, at step 392, the consumer's database record in the consumer database (260) is updated with the transmitted information. Finally, in step 393 a confirmation display.html file is created and transmitted in step 379 back to the web browser (207).

In this kind of embodiment, if the request is for the PDAlogonpage, at step 455, web server (220) receives the HTTP document request for PDAlogonpage.html (407), determines where on the system PDAlogonpage.html (407) resides and transmits in step 379 the PDAlogonpage.html (407) file over the TCP/IP connection on the Internet (279) back to the gateway server (227). Gateway server (227) receives the PDAlogonpage.html (407) web page, converts the web page to PDAlogonpage.wml, and transmits the web page to the micro-web browser (225).

In this kind of embodiment, if the request is to process a comparison request, at step 465 the web server initiates execution of comparison component script (255). In step 465, comparison component (255), retrieves the scanned product codes and customer identification from the transmitted information. Then, at step 470, utilizing the consumer identification, the consumer's allergy information is retrieved from the consumer's database (260). Utilizing the UPC the allergy information for each scanned product code is retrieved from the product code databases (105) at step 470. In the illustrated embodiment, at step 475, the customer's allergy information is compared with the allergy information of each scanned product. In step 471, the results.html file is generated and this file contains the results of the comparison. The generated file is transmitted at step 379 back to the micro-web browser (225) via the gateway server (227).

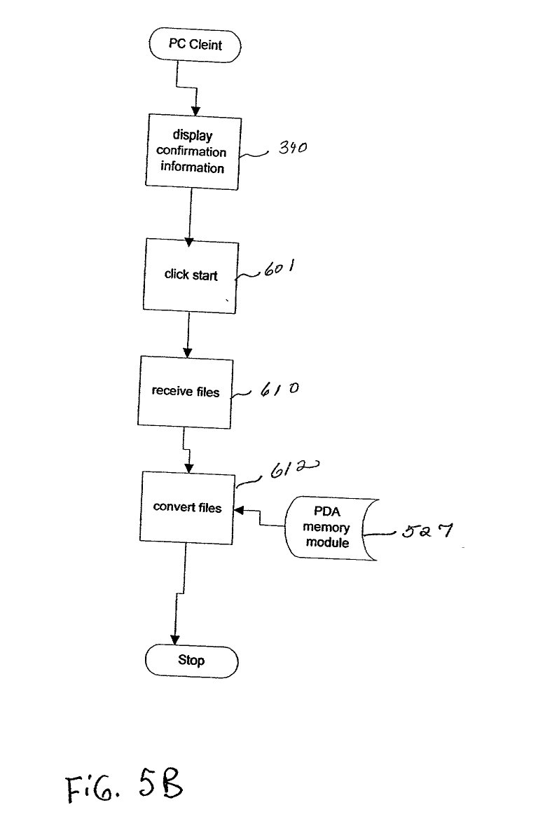

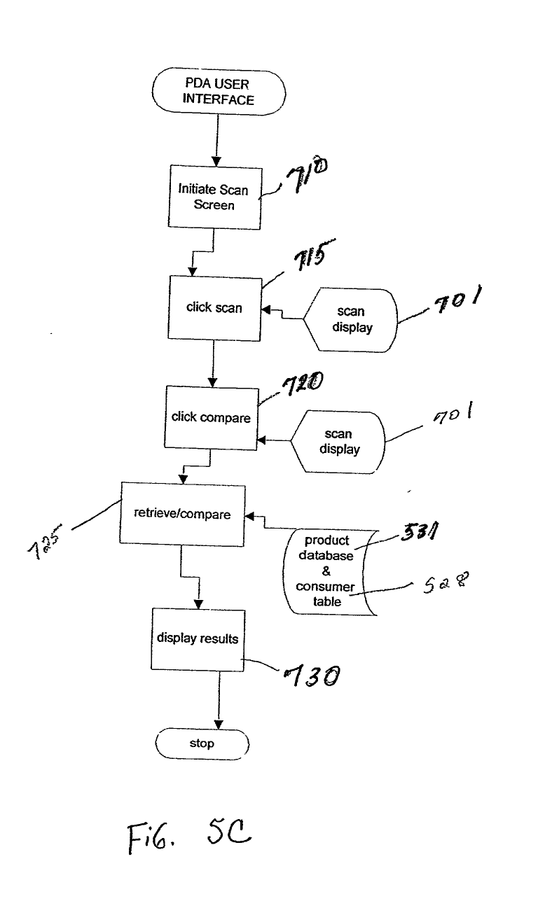

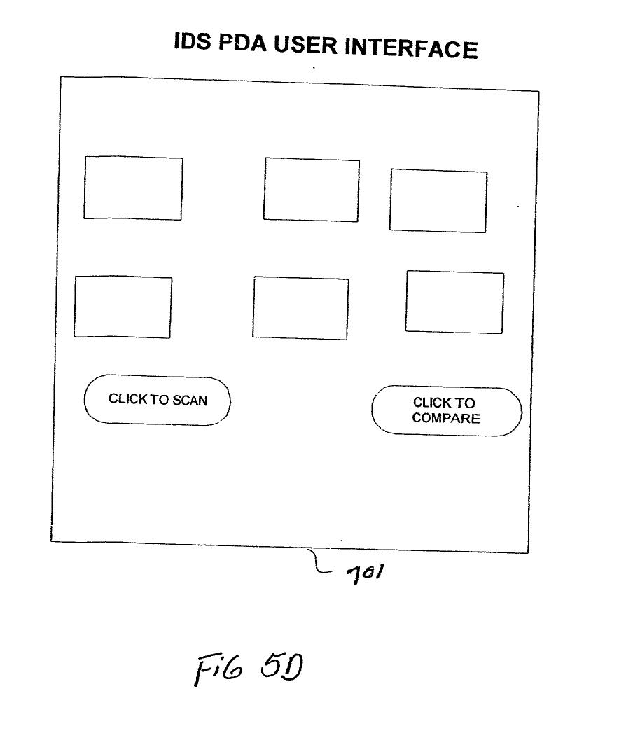

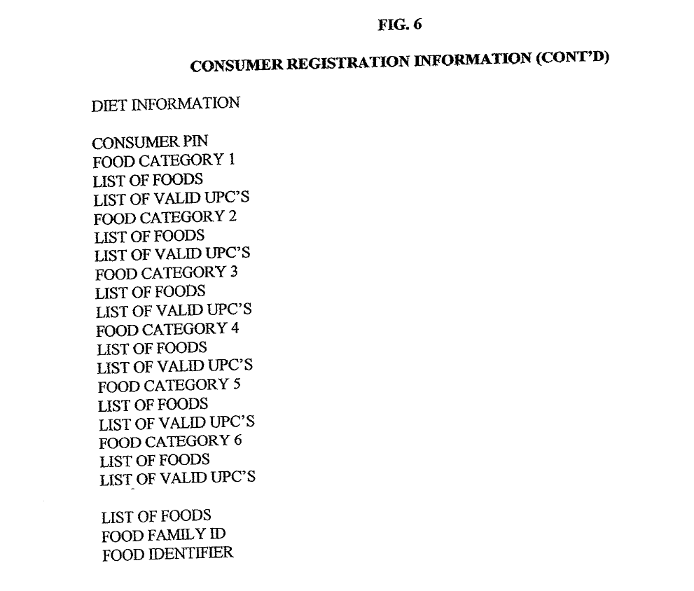

Referring now to FIG. 5A, there is shown a block diagram of an alternative embodiment of an environment, which supports the present invention. This system is also implemented in an client-server environment. However, in this illustrated environment, the PDA does not utilize a wireless connection to access the databases stored on the web server. The illustrated system includes at least one stand alone hand-held Personal Digital Assistant (PDA) (515) in communication with a client computer (510) and at least one client computer (510) in communication with least one Web Server Computer (550) via the Internet or an Intranet (502). The client computer (510) can be a Personal Computer, Lap Top, Notebook or another such compatible computer processing system. The client computer (505) further includes a web browser (507). Web browser (507) is software which provides the capability of connecting to the web server (520), requesting web pages from the web server (520), pulling the web pages through Internet (502), interpreting the set of HTML tags within the web pages (545), and displaying the web pages (545) on the screen of the client computer (505). Web browser (507) can be any commercially available software product, such as Netscape or Microsoft Internet Explorer.

In the illustrated embodiment, client computer (510) further includes, PDA desktop component (508). PDA desktop (508) is conventional software provided with the PDA (515) which provides the capability of downloading from the web server (550) a version of the product databases (505) which are specifically designed to support the services specified by the consumer during registration. Additionally, the PDA desktop component (508), has the capability of converting the product databases (505) into a PDA version of the product databases (531) and transferring that version to memory module (527) connected to PDA (515). The PDA desktop (508) further includes the capability of downloading from web server (520) to the client computer (510) the specific consumer information (528) from consumer database (560) along with the blood table (529). The consumer information (528) and the blood table (529) is also transferred to memory module (527).

In the illustrated embodiment, PDA (515) can be a palm computer, handspring visor, or another such compatible hand-held computer processing system. PDA (515) further includes memory module (527), user interface component (557) and comparison component (555). In the illustrated embodiment, user interface component (557) interfaces with the consumer to obtain logon information and then validates the consumer provided logon information against the consumer information stored in the consumer table (528) stored in memory module (527). After validation of the logon information, the consumer is prompted to scan selected manufactured products. Utilizing the information stored in the PDA version of product databases (531), blood table (529) and the consumer table (528) stored in memory module (527), comparison component (555) processes consumer requests without directly communicating with the web server.

In the illustrated embodiment, scanner (530) is connected to PDA (515) and a commercially available software driver is installed on PDA (515). Scanner (530) provides the capability to scan in the UPC bar codes from the manufactured products. The software driver retrieves the scanned bar codes and converts the information to text. The comparison component (555) is then capable of accessing the converted scanned bar codes. Scanner (530) can be the CSM 150 manufactured by Symbol Technologies or another such compatible processing system.

In the illustrated embodiment in FIG. 5A, web sever (520) further includes search engine (540), product databases (505), Web pages (545), Blood table (547), Create/Maintain Component (549), registration component (548) and consumer database (560). Search engine (540) processes HTTP requests for web pages (545) from web browser (507). Create/Maintain Component (549) creates the product databases (505) from provided manufactured product information. The product databases (505) contains a list of allergy components for each manufactured product stored in the database. Registration component (548) creates Consumer database (560) from the consumer information provided by each consumer during the registration process. Consumer database (560) contains the personal and allergy information for each consumer that registers with the system. Blood table (547) is the same as describe in FIG. 4B.

FIGS. 5B-5D are flow charts illustrating how this embodiment of the present invention registers a consumer, downloads into PDA memory module from the web server, performs the comparison process, and provides the results back to the consumer.

In this embodiment, the consumer registers as illustrated above in FIG. 3A. However, as illustrated in FIG. 5B an additional step 601 is required to transfer the product database(s), blood table, and the specific consumer information into the PDA memory module. Referring to FIG. 5B, in step 340, after the consumer completes registration, the consumer is prompted to initiate the PDA file transfer in the returned confirmation display screen. At step 601, after the consumer clicks on the start button, the web server transfers the files via the Internet to the PC client. In step 610, the files are received from the web server and stored on the PC Client. Then, in step 612, utilizing the PDA desktop software, the received files can then be converted into PDA compatible files and transferred into the PDA memory module (527).

In alternative PDA embodiments, the PDA can have the capability of downloading the required files from the web server directly to the PDA memory module (527) utilizing a wireless connection.

In yet an even more specific embodiment, prior to allowing the consumer to scan UPC codes, the PDA user interface will prompt the consumer to synchronize the databases stored in the PDA memory module (527) with the databases stored on the web server. In this specific embodiment, the consumer will not be allowed to proceed to the comparison process until the PDA database synchronization process is complete.

In the illustrated embodiment in FIG. 5B, specific consumer information is transferred from the web server into the PDA module based upon the provided logon and password. In an even more specific embodiment, the consumer information can be directly inputted by the customer into PDA (515) using user interface component (525). In yet an even more specific embodiment of the present invention, after the consumer completes registration, the consumer can be provided an identification device. The identification device can be a smart card or a magnetic bar card encoded with the customer's profile. In this more specific embodiment, user interface component (525) would have conventional software which would provide the capability of reading and validating the encoded consumer information on the smart card or magnetic bar code against what is stored in the consumer database. After the encoded consumer information is verified, the encoded consumer's profile containing the list of elements can then be stored in the PDA memory module.

Referring now to FIG. 5C, in the illustrated embodiment, after the consumer registration is complete and the database files are transferred to the PDA memory module, using the user interface module, the consumer can then select products to test for allergic reactions. A sample display of PDA scan screen (701) illustrated in FIG. 5D. In the illustrated embodiment, in step 710, the consumer initiates the execution of the PDA scan screen (701). In step 715, the PDA scan screen (701) allows the consumer to click the scan button several times to input UPC product codes into the PDA scan screen (701). At step 720, upon completing scanning the of the selected products, the consumer clicks the compare button to initiate the comparison process. Then, at step 725, the allergy components of each selected product is retrieved from the product database(s) (531). In step 725, the allergy components of each selected product is compared against the consumer's allergy information stored in the consumer table (528). The results of the comparison is displayed to the consumer at step 730.

In some alternative embodiments of this system, a diet can be generated which is consistent with the provided consumer profile. Referring back to the illustrated embodiment in FIG. 4, in step 393, the server can generate a diet based upon the list of allergies provided at step 376. In step 393, a diet information database record is created. The diet becomes part of the consumer profile stored in the consumer database. The diet information can include a meal, food category, list of foods, and list of UPC's. A meal can be breakfast, lunch, dinner, snack. A food category can be breads, cereals, or any such type of compatible food family. Within each food category are is a list of foods that can be eaten by the consumer. As the consumer purchase products to meet the generated diet, a list of verfied UPC's is added to the consumer profile. In the illustrated embodiment in FIG. 4, the list of UPC's can be generated in step 471. In step 471, before the results are returned to the consumer, for that particular UPC, the system determines what particular food category the UPC belongs to. Then, the UPC is stored in the consumer database within the determined food category. Additionally in this specific embodiment, the user interface illustrated in FIG. 5D and the PDS SCAN page illustrated in FIG. 3H would provide the capability through a button to recall the diet.

In yet another alternative embodiment of the present invention, the PDA can be replaced with a convention point of sale electronic computing device or a conventional static portable scanning device. The client computer and the server computer functions equivalent to as describe above for FIGS. 5A and 5B. However, there can an additional data communication link between the Server and the POS in which the product database(s) and consumer table and blood table can be downloaded directly into a storage device connected to the POS instead of using the Internet. The POS or static scanning device is augmented with the capability of validating the consumer identification device, performing the comparison process, and notifying the comparison results to the consumer.

In this alternative embodiment, initially the consumer and the manufacturers must register with the server. The registration process can be performed with a client computer and a server that is part of the commercial establishment. Commercial establishment can be a retailer, wholesaler, manufacturer, distributor, reseller, or any such type of compatible establishment. The consumer can register with a client computer located within the commercial establishment. In this kind of embodiment, after the consumer completes registration, the consumer selects products and proceeds to the POS checkout register or the static scanning device in which both are located in the commercial establishment. At the check out register or static device, the consumer presents their consumer identification device. The consumer identification device is electronically read into the POS or static device. Then, the consumer identification device is validated with what is stored in the consumer table. If the consumer identification device is valid, the consumer profile containing the list of identified element is retrieved from the consumer table. Next, the product code on the label of each selected product is scanned into the system. For each scanned product, the list of contents are retrieved from the product database and compared with the list of identified elements. The consumer is then notified of which selected products contain any of elements contained on the list of identified elements. The system can notify the consumer with a receipt that highlights the affected products. Additionally, the consumer can be notified verbally or visually. After notification, the consumer can be asked to acknowledge by signature on the notification receipt the purchase or receipt of products.

In yet another alternative embodiment of the present invention, the system environment can comprise at lease one computer server in communication with at least one electronic computing device. The manufacturer registers their products with the server, which maintains a product database. The product database can be housed on the server or the electronic computing device. Additionally, a subset of the product database can be housed on the electronic computing device. The electronic computing device can be a handheld device or a stationary scanning device. In this kind of embodiment, no consumer database is maintained through a registration process. In this embodiment, the consumer directly inputs their consumer profile containing the list of identified elements along with the selected products into the electronic computing device. Then, the electronic computing device accesses the product database stored locally or on the server. The comparison process is done and the consumer is notified the results.

The operating system environment of the present invention can comprise a plurality of servers simultaneously communicating with a plurality of electronic computing devices as well as simultaneously communicating with consumers registering via client computers. The system of the present invention comprises computer software executable instructions installed and running on each server as well as each electronic computing device. The above described server functions of maintaining and creating the product databases, registering the consumer, and maintaining and creating the consumer databases are software executable instructions installed and running on the server. The above described functions of the electronic computing device of accessing the consumer identification device, validating the consumer identification device, performing the product comparison process, and notifying the consumer of the results of the comparison are software executable instructions installed and running on the electronic computing device.

What is claimed is:

1. A computerized system for notifying consumers that particular elements are contained in selected products, the system comprising:
at least one computer server having a first storage media and a first processor;
the first storage media containing a first database including a list of contents for a plurality of product codes;
the first processor programmed to maintain the first database contained in the first storage media;
at least one electronic computing device in communication with the at least one computer server; and
the at least one electronic computing device having a second processor programmed to:
receive the consumer's registration information containing a consumer's profile and a list of elements identified by the consumer;
receive as input a plurality of product codes selected by the consumer; and
for each inputted product code, the second processor is further program to:
retrieve the list of contents from the first database corresponding to the product code;
compare the list of contents with the consumer's list of identified elements; and
notify the consumer whether the selected product corresponding to the product code contains any of the identified elements.

2. The system of claim 1, wherein the first processor is further programmed to:
receive as input from the consumer the consumer's registration information;
store and maintain the consumer's registration information in a second database located on the at least one server; and
provide to the consumer a consumer identification device corresponding to the stored consumer profile, whereby the consumer identification device is a reference which links the consumer to the registered consumer's profile.

3. The system of claim 2, wherein the second processor is further program to:
access the consumer identification device;
access the consumer's profile from the second database based upon the consumer identification device;
validate the consumer identification device with what is stored in the consumer's profile; and
transfer the consumer's registration information into the electronic computing device.

4. The method of claim 3, wherein the consumer identification device contains all or part of the consumer's registration information.

5. The method of claim 1, wherein the first database consists of a plurality of tables.

6. The method of claim 2, wherein the second database consists of plurality of tables.

7. The method of claim 1, wherein the consumer is a person, entity or animal.

8. The method of claim 1, wherein the product code identify a consumable good, a manufactured good, or a product sold in its natural state.

9. The method of claim 1, wherein the electronic computing device is a handheld computing device, stationary scanning device or a point of sale computing device.

10. The method of claim 1, wherein the second processor is further programmed to notify the consumer of which selected products contain any of the identified elements and to receive from the consumer an acknowledgment of each notification given to the consumer.

11. The system of claim 5, wherein the second processor is further programmed to:
electronically receive the first database or a subset of the tables from the at least one server; and
store the first database in a second storage media connected to the at least one electronic computing device.

12. The system of claim 1, further comprising:
a scanning device connected to the at least one electronic computing device; and
the scanning device is programmed to scan from the product label the product code.

13. The system of claim 1, wherein the product code is an Universal Product Code (UPC) bar code.

14. The system of claim 6, wherein the second processor is further programmed to:
receive the second database or a subset of the plurality of tables from the at least one server; and
store the second database in a third storage media connected to the at least one electronic computing device.

15. The system of claim 1, wherein the at least one server further includes a third storage media containing a blood table which includes a list of elements for each possible blood type a consumer can have.

16. The system of claim 15, wherein the consumer's registration information further includes the consumer's blood type and an additional list of elements retrieved from the blood table based upon the consumer's blood type.

17. The system of claim 2, wherein the first processor is programmed to:
generate a diet from the consumer's registration information; and
store the diet as part of the consumer's profile.

18. A computerized method for notifying consumers particular elements are contained in selected products, the method comprising the steps of:
maintaining a first database in a storage media on at least one computer server, the first database including a list of contents for a plurality of product codes;
inputting a list of elements identified by the consumer into an electronic computing device;
inputting a plurality of product codes selected by the consumer into the electronic computing device; and
for each inputted product code perform the steps of:
retrieving from the first database a list of contents corresponding to the product code; and
comparing the list of elements with the list of product contents;
and notifying to the consumer whether the selected product corresponding to the product code contain any of the identified elements.

19. The method of claim 18, wherein the step of inputting a list of elements further includes the steps of:
registering a consumer's profile in a second database, the consumer profile including the list of elements identified by the consumer;
maintaining the second database on the at least one computer server; and
providing the consumer with a consumer identification device corresponding to the stored consumer profile, whereby the consumer identification device is a reference link back to the registered consumer profile.

20. The method of claim 19, further including the steps of:
accessing the consumer's identification device;
accessing the consumer's profile from the second database based upon the consumer's identification device;
validating the consumer's identification device with what is stored in the consumer's profile; and
transferring the consumer's profile into the electronic computing device.

21. The method of claim 19 wherein the consumer identification device contains all or part of the consumer's registered profile.

22. The method of claim 18, wherein the first database consists of a plurality of tables.

23. The method of claim 19, wherein the second database consists of a plurality of tables.

24. The method of claim 18, wherein the consumer is a person, entity or animal.

25. The method of claim 18, wherein the product is a consumable good, a non-consumable good, a manufactured good, or a product sold in its natural state.

26. The method of claim 18, wherein the electronic computing device is a handheld computing device, stationary scanning device, or a point of sale computing device.

27. The method of claim 18, wherein the step of notifying further comprises receiving from the consumer an acknowledgment of each notification that a selected product contains an identified element.

28. The method of claim 19, wherein the step of registering the consumer further includes the steps of:
generating an additional list of elements based upon the consumer's blood type;
and registering the additional list of elements as part of the consumer's profile.

29. The method of claim 19 further comprising the steps of:
generating a diet based upon the consumer's registration information; and
storing the diet as part of the consumer's profile in the second database.

30. The method of claim 22 further comprising the step of transferring the first database or a subset of the first database to a second storage media connected to the electronic computing device.

31. The method of claim 23 further comprising the step of transferring the second database or a subset of the tables to a third storage device connected to the electronic computing device.

32. A computer medium having computer-executable instructions for performing a method, the method comprising the steps of:
maintaining a first database in a storage media on at least one computer server, the first database including a list of contents for a plurality of product codes;
inputting a list of elements identified by the consumer into an electronic computing device;
inputting a plurality of product codes selected by the consumer into the electronic computing device; and
for each inputted product code perform the steps of:
retrieving from the first database a list of contents corresponding to the product code; and
comparing the list of elements with the list of product contents;
and notifying to the consumer whether the selected product corresponding to the product code contain any of the identified elements.

33. The computer-readable medium of claim 32, wherein the computer instructions to perform the step of inputting a list of elements further includes computer instruction to perform the steps of:
registering a consumer's profile in a second database, the consumer profile including the list of elements identified by the consumer;
maintaining the second database on the at least one computer server; and
providing the consumer with a consumer identification device corresponding to the stored consumer profile, whereby the consumer identification device is a reference link back to the registered consumer profile.

34. The computer-readable medium of claim 33, further including computer executable instructions to perform the steps of:
accessing the consumer's identification device;
accessing the consumer's profile from the second database based upon the consumer's identification device;
validating the consumer's identification device with what is stored in the consumer's profile; and
transferring the consumer's profile into the electronic computing device.

35. The computer-readable medium of claim 32 having computer executable instruction to define the consumer identification device containing all or part of the consumer's registered profile.

36. The computer-readable medium of claim 32 having computer executable instruction to define the first database consisting of a plurality of tables.

37. The computer-readable medium of claim 32 having computer executable instruction to define the second database consisting of a plurality of tables.

38. The computer-readable medium of claim 32, wherein the computer instructions to perform the step of notifying further comprises instructions to perform the step of receiving from the consumer an acknowledgment of each notification that a selected product contains an identified element.

39. The computer-readable medium of claim 33, wherein the computer instructions to perform the step of registering the consumer further includes instructions to perform the steps of:
generating an additional list of elements based upon the consumer's blood type;
and registering the additional list of elements as part of the consumer's profile.

40. The computer-readable medium of claim 33, further comprising instructions to perform the steps of:
generating a diet based upon the consumer's registration information; and
storing the diet as part of the consumer's profile in the second database.

41. The computer-readable medium of claim 36, further comprising computer instructions to perform the step of transferring the first database or a subset of the first database to a second storage media connected to the electronic computing device.

42. The computer-readable medium of claim 37, further comprising computer instructions to perform the step of transferring the second database or a subset of the tables to a third storage device connected to the electronic computing device.
